(19) United States
(12) Patent Application Publication
(10) Pub. No.: US 2019/0080540 A1
(43) Pub. Date: Mar. 14, 2019

(54) SYSTEM AND METHOD FOR CONTROLLING VEHICLE

(71) Applicants: Hyundai Motor Company, Seoul (KR); Kia Motors Corporation, Seoul (KR)

(72) Inventor: HyunChul SIM, Suwon-si (KR)

(73) Assignees: Hyundai Motor Company, Seoul (KR); Kia Motors Corporation, Seoul (KR)

(21) Appl. No.: 15/836,033

(22) Filed: Dec. 8, 2017

(30) Foreign Application Priority Data
Sep. 13, 2017 (KR) 10-2017-0117004

(51) Int. Cl. G07C 9/00; B60R 25/25; B60R 25/24

(52) U.S. Cl. CPC G07C 9/00563; B60R 25/252; B60R 25/241; G07C 9/00158; B60R 25/255; G07C 2009/00269; B60R 2325/205; G07C 2009/00293; G07C 9/00309

(57) ABSTRACT

A system and method for controlling a vehicle are disclosed, which reduce a standby time of a user who controls the vehicle using a mobile device, minimize the number of user manipulation times, and guarantee higher security, may include a mobile device and a controller, wherein the mobile device generates not only a hash key and an encryption key received from a server, but also an encrypted control command through biometric authentication information received from a user and wherein the controller receives the encrypted control command from the mobile device through a short-range communication network, decrypts the encrypted control command using a hash key and a decryption key received from the server, and performs control corresponding to the control command.

### CROSS-REFERENCE TO RELATED APPLICATION

The present application claims priority to Korean Patent Application No. 10-2017-0117004, filed on Sep. 13, 2017, the entire contents of which is incorporated herein for all purposes by this reference.

### BACKGROUND OF THE INVENTION

### Field of the Invention

The present invention relates to a vehicle, and more particularly, to an apparatus and method for controlling a vehicle using a mobile device.

### Description of Related Art

Generally, there are a variety of methods for allowing a driver (or user) to unlock doors of a parked vehicle and start engine ignition by the driver who rides in the vehicle. According to the most basic one of the methods, the driver unlocks the doors of the vehicle using a physical key, rides in the vehicle, inserts the physical key into a key box, and turns the physical key to a start position, starting engine ignition of the vehicle. With rapid development of wireless communication technology, improved technologies capable of unlocking doors of the vehicle and starting the engine using a remote controller called a key fob, an immobilizer, or a smart key have been developed and rapidly come into widespread use.

In recent times, advanced technologies capable of locking/unlocking doors of the vehicle and starting engine ignition of the vehicle using an application (App) of a mobile device without using the physical key of the vehicle have been widely used throughout the world. The above-mentioned vehicle control method using the application (App) of the mobile device is basically based on wireless communication among the mobile device, the vehicle, and a server located at a remote site.

However, whenever doors of a parked vehicle turned off need to be unlocked, the application (App) of the mobile device is first driven, the mobile device drives a vehicle controller (e.g., Audio Video Navigation (AVN)) by communicating with the server located at a remote site, and the doors of the parked vehicle are finally unlocked by the vehicle controller, resulting in consumption of a long period of time in unlocking the doors of the vehicle. As a result, a standby time of a user or driver of the vehicle is also increased, resulting in greater inconvenience of the user or driver.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a technology for reducing a standby time of a user who controls a vehicle using a mobile device, minimizing the number of user manipulation times, and guaranteeing higher security.

Additional aspects of the invention will be set forth in part in the description which follows and, in part, will be obvious from the description, or may be learned by practice of the invention.

In accordance with an aspect of the present invention, a system for controlling a vehicle may include a transceiver receives a hash key and an encryption key received from a server, but also an encrypted control command through biometric authentication information received from a user from a mobile device, and a controller configured to receive the encrypted control command from the mobile device through a short-range communication network, decrypt the encrypted control command using a hash key and a decryption key received from the server, and perform control corresponding to the control command.

The biometric authentication may be achieved using biometric information related to the user of the mobile device.

Communication with the server may be achieved through a mobile communication network. Communication between the mobile device and the controller may be achieved through the short-range communication network.

The control command may be automatically generated after completion of the biometric authentication.

The short-range communication network may be a Bluetooth communication network.

The control command may be a command for unlocking at least one door of the vehicle.

The command for unlocking the at least one door of the vehicle may be generated only when the vehicle is parked.

In accordance with another aspect of the present invention, a method for controlling a vehicle may include receiving a hash key and a decryption key from a server through a mobile communication network, receiving an encrypted control command generated through biometric authentication of a user of a mobile device from the mobile device through a short-range communication network, and decrypting the encrypted control command received from the mobile device, and performing control corresponding to the control command.

The control command may be automatically generated after completion of the biometric authentication.

The short-range communication network may be a Bluetooth communication network.

The control command may be a command for unlocking at least one door of the vehicle.

The command for unlocking the at least one door of the vehicle may be generated only when the vehicle is parked.

In accordance with another aspect of the present invention, a method for controlling a vehicle may include, when an application for controlling the vehicle is executed, receiving a hash key and an encryption key from a server through a mobile communication network, accessing a short-range communication network located in a peripheral region of the vehicle, and receiving a hash key transmitted through the short-range communication network, when the hash key received from the server is identical to the hash key received through the short-range communication network, entering a standby mode until biometric authentication of a user is completed, and when the biometric authentication of the user is completed, encrypting a control command for controlling the vehicle and transmitting the encrypted control command to the vehicle through the short-range communication network, such that the vehicle having received the control command performs control corresponding to the control command.

The biometric authentication may be achieved using biometric information related to the user in the mobile device held by the user.

The control command may be automatically generated after completion of the biometric authentication.

The short-range communication network may be a Bluetooth communication network.

The control command may be a command for unlocking at least one door of the vehicle.

The command for unlocking the at least one door of the vehicle may be generated only when the vehicle is parked.

In accordance with another aspect of the present invention, a method for controlling a vehicle may include, when an application for controlling the vehicle is executed, receiving a hash key and an encryption key from a server through a mobile communication network, receiving a hash key and a decryption key from the server through the mobile communication network, accessing a short-range communication network located in a peripheral region of the vehicle, and receiving a hash key transmitted through the short-range communication network, when the hash key received from the server is identical to the hash key received through the short-range communication network, entering a standby mode until biometric authentication of a user is completed, when the biometric authentication of the user is completed, encrypting a control command for controlling the vehicle, and transmitting the encrypted control command to the vehicle through the short-range communication network, receiving the encrypted control command generated through the user biometric authentication of a mobile device from the mobile device through the short-range communication network, and decrypting the encrypted control command received from the mobile device, and performing control corresponding to the control command.

The control command may be automatically generated after completion of the biometric authentication.

The short-range communication network may be a Bluetooth communication network.

The control command may be a command for unlocking at least one door of the vehicle.

The command for unlocking the at least one door of the vehicle may be generated only when the vehicle is parked.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a communication system for controlling a vehicle according to an exemplary embodiment of the present invention.

FIG. 2 is a diagram illustrating the communication system shown in FIG. 1 according to an exemplary embodiment of the present invention.

FIG. 3 is a flowchart illustrating a method for controlling a vehicle according to an exemplary embodiment of the present invention.

It may be understood that the appended drawings are not necessarily to scale, presenting a somewhat simplified representation of various features illustrative of the basic principles of the invention. The specific design features of the present invention as included herein, including, for example, specific dimensions, orientations, locations, and the shapes will be determined in part by the particularly intended application and use environment.

In the figures, reference numbers refer to the same or equivalent parts of the present invention throughout the several figures of the drawing.

### DETAILED DESCRIPTION

Reference will now be made more specifically to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Reference will now be made more specifically to the exemplary embodiments of the present invention, examples of which are illustrated in the accompanying drawings, wherein like reference numerals refer to like elements throughout.

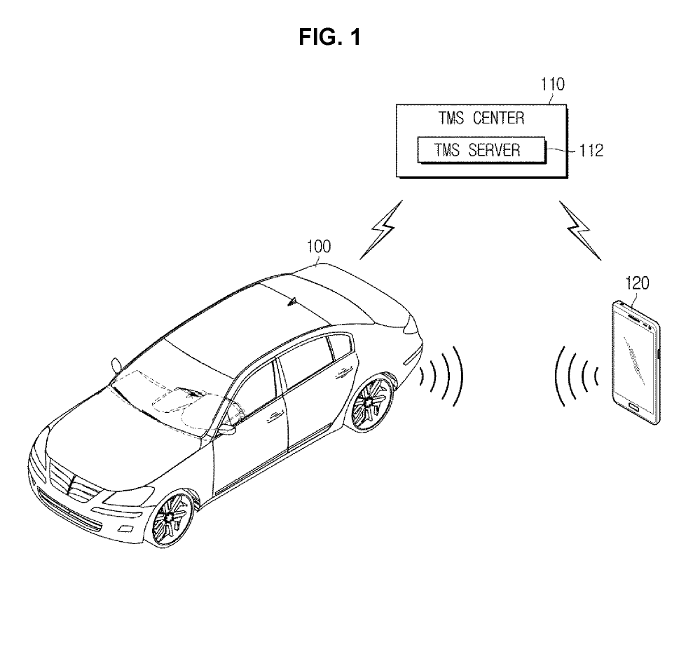

FIG. 1 is a view illustrating a communication system for controlling a vehicle according to an exemplary embodiment of the present invention. Referring to FIG. 1, the communication system according to the exemplary embodiment of the present invention may be configured to implement communication among a vehicle 100, a telematics center 110, and a mobile device 120. In FIG. 1, a short-range communication scheme may be used between the vehicle 100 and the mobile device 120. The short-range communication scheme may be implemented as any of Bluetooth Low Energy (BLE), Near Field Communication (NFC), ZigBee, etc. Communication between the vehicle 100 and the telematics center 110 or communication between the mobile device 120 and the telematics center 110 may be implemented using a mobile communication network. The mobile communication network may include a communication network such as a Long Term Evolution (LTE) network. The mobile device 120 may be held by a user who desires to use the vehicle 100.

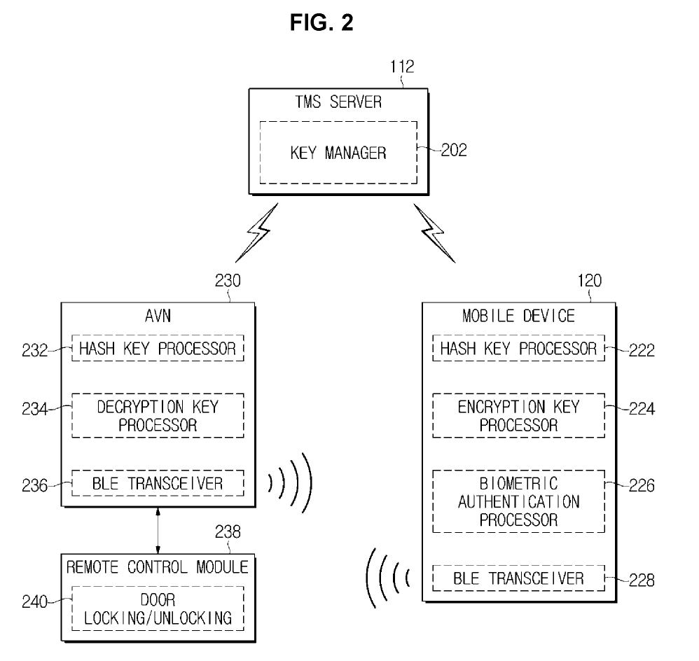

The vehicle 100 may include an AVN (230 of FIG. 2), and may communicate with the telematics center 110 or the mobile device 120 through the AVN 230. For the present purpose, the vehicle 100 may have authority to use a telematics service, may access a telematics (TMS) server 112 of the telematics (TMS) center 110, and may be paired with the mobile device 120 through a short-range communication network. The AVN 230 may be only an example of a controller of the vehicle 100, and may be the other control device (e.g., electronic control unit ECU) configured for performing communication and control.

Furthermore, the vehicle 100 may include a remote control module (238 of FIG. 2) which is configured for locking/unlocking doors of the vehicle using a remote controller and at the same time starting engine ignition of the vehicle.

The telematics center 110 may include the telematics server 112. The telematics server 112 may generate a hash key and encryption/decryption keys, and may simultaneously transmit the hash key and the encryption/decryption keys to the vehicle 100 and the mobile device 120 through a mobile communication network.

The mobile device 120 may include a vehicle control application (App) for allowing a user to control the vehicle 100 through the mobile device 120. The user may have authority to control the vehicle 100 through the vehicle control application (App) embedded in the mobile device 120. However, the user is unable to have authority to control the vehicle 100 by executing only the vehicle control application (App), and a separate authentication process is needed for the authority to control the vehicle 100.

FIG. 2 is a diagram illustrating the communication system shown in FIG. 1 according to an exemplary embodiment of the present invention.

Referring to FIG. 2, the telematics server 112 may include a key manager 202. The key manager 202 of the telematics server 112 may generate a hash key and encryption/decryption keys. The hash key and the encryption/decryption keys generated from the key manager 202 may be simultaneously transmitted to the mobile device 120 through the mobile communication network.

The mobile device 120 may include a hash key processor 222, an encryption key processor 224, a biometric authentication processor 226, and a Bluetooth Low Energy (BLE) transceiver 228.

The hash key processor 222 may receive a hash key from the telematics server 112, and may store the received hash key therein.

The encryption key processor 224 may receive an encryption key from the telematics server 112, and may store the received encryption key. Through the encryption key, a command (for example, a command for locking/unlocking doors of the vehicle) for controlling the vehicle 100 may be encrypted through the encryption key.

When the user desires to perform biometric authentication using the mobile device 120, the biometric authentication processor 226 may acquire biometric information (e.g., fingerprint or iris information) from the user, may store the acquired biometric information, and may compare the stored biometric information with previous biometric information pre-registered in the mobile device 120. When the newly received biometric information is identical to the previous biometric information, the biometric authentication processor 226 may authenticate the user who is a registered person of the corresponding biometric information, and may allow the user to use the mobile device 120.

The BLE transceiver 228 may perform Bluetooth communication with the mobile device 120.

The AVN 230 may include a hash key processor 232, a decryption key processor 234, and a BLE transceiver 236.

The hash key processor 232 may receive a hash key from the telematics server 112, and may store the received hash key.

The decryption key processor 234 may receive a decryption key from the telematics server 112, and may store the decryption key. Through the decryption key, an encrypted command (e.g., a command for locking/unlocking doors of the vehicle) for controlling the vehicle 100 may be decrypted.

The BLE transceiver 236 may perform Bluetooth communication with the mobile device 120.

The remote control module 238 may include a door locking/unlocking function 240. The vehicle 100 may perform locking or unlocking of doors of the vehicle through the remote control module 238. The remote control module will hereinafter be referred to as a smart key module.

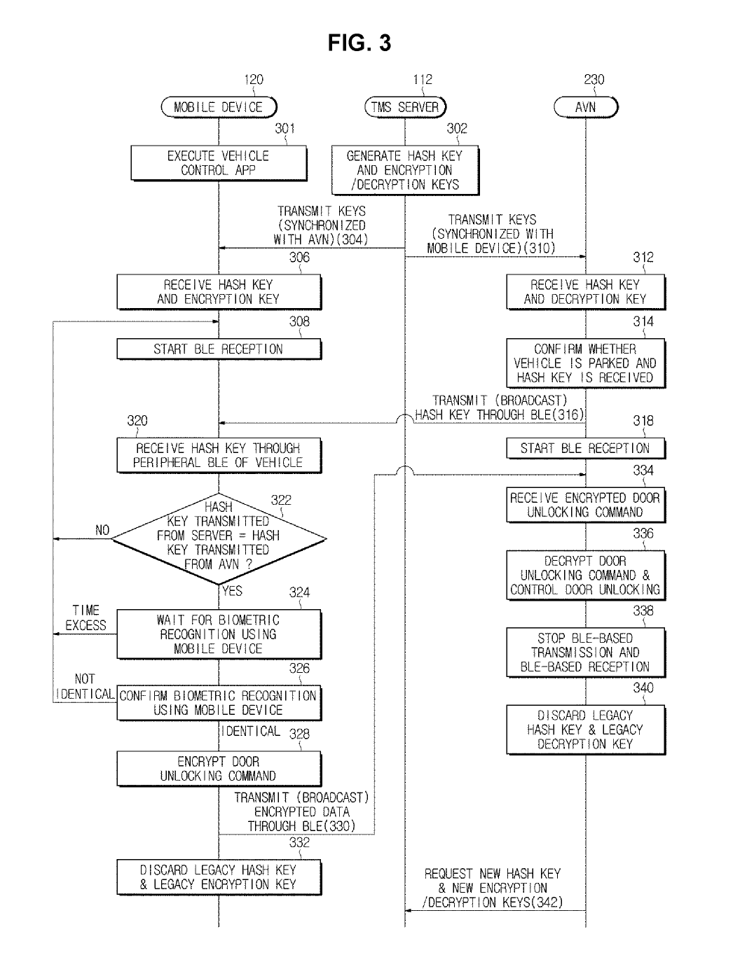

FIG. 3 is a flowchart illustrating a method for controlling a vehicle according to an exemplary embodiment of the present invention. The control method of FIG. 3 may be conducted based on constituent elements shown in FIG. 1 or FIG. 2.

Referring to FIG. 3, a vehicle control application software (App) may be executed in the mobile device 120 by the user (301). When the vehicle control App is executed in the mobile device 120, the environment configured for receiving a new hash key and a data encryption key may be provided. Reception of the new hash key and the data encryption key may be executed as a background task in the mobile device 120. Whenever the user executes the vehicle control App in the mobile device 120, the new hash key and the data encryption key may be received by the mobile device 120. The mobile device 120 may continuously receive the new hash key and the data encryption key until execution of the vehicle control App is end portioned. The new hash key and the data encryption key will be described in operation 302 to be described later.

The telematics server 112 may generate the hash key and the encryption/decryption keys (302). The telematics server 112 may generate the hash key and the encryption/decryption keys for every predetermined time point. As an example of the predetermined time point, the telematics server 112 may generate the hash key and the encryption/decryption keys at intervals of a predetermined period or whenever a key generation command is output. Here, the setting of the predetermined period or the generation of the key generation command may be achieved by user manipulation.

The hash key may be a unique identification (ID) value allocated to data communicated among the telematics server 112, the mobile device 120, and the AVN 230. When plural data have the same hash key, the plural data may be identical to each other. When plural data have different hash keys, the plural data may be different from each other.

The encryption key may be a key for encrypting (or encoding) data communicated among the telematics server 112, the mobile device 120, and the AVN 230. That is, when encrypting data in the mobile device 120, the encryption key is needed. When the encryption key is not present, the mobile device 120 is unable to encrypt data.

The decryption key may be a key for decrypting (or decoding) encrypted data communicated among the telematics server 112, the mobile device 120, and the AVN 230 to a previous value prior to data encryption. That is, when decrypting data in the AVN 230, the decryption key is needed. When the decryption key is not present, the AVN 230 is unable to decrypt encrypted data.

The telematics server 112 may transmit the hash key and the encryption key from among the hash key and the encryption/decryption keys to the mobile device 120 (304). Transmitting keys from the telematics server 112 to the mobile device 120 may be synchronized with transmitting keys from the telematics server 112 to the AVN 230, such that the transmitting the keys from the telematics server 112 to the mobile device 120 and the transmitting the keys from the telematics server 112 to the AVN 230 may be simultaneously conducted. In other words, the telematics server 112 may simultaneously transmit the hash key and the encryption/decryption keys to the mobile device 120 and the AVN 230 (304 and 310).

Since the environment configured for receiving the new hash key and the encryption key by execution of the vehicle control App is provided (301), the mobile device 120 may receive the hash key and the encryption key from the telematics server 112 (306). In the instant case, communication between the mobile device 120 and the telematics server 112 may be achieved through a mobile communication network including a Long Term Evolution (LTE) network.

Subsequently, the mobile device 120 may activate Bluetooth communication (308). The Bluetooth communication may be communication based on Bluetooth Low Energy (BLE) technology. The scope or spirit of the present invention is not limited to Bluetooth communication, and another short-range communication technology including NFC or ZigBee may also be applied to the present invention. Through activation of Bluetooth communication, the environment in which the mobile device 120 may receive data by accessing a Bluetooth communication network may be provided in the mobile device 120.

The telematics server 112 may transmit the hash key and the decryption key from among the hash key and the encryption/decryption keys generated in operation 302 to the AVN 230 (310). Transmitting keys from the telematics server 112 to the AVN 230 may be synchronized with transmitting keys from the telematics server 112 to the mobile device 120, such that the transmitting the keys from the telematics server 112 to the AVN 230 and the transmitting the keys from the telematics server 112 may be simultaneously conducted. In other words, the telematics server 112 may simultaneously transmit the hash key and the encryption/decryption keys to the mobile device 120 and the AVN 230 (304 and 310).

The AVN 230 may receive the hash key and the decryption key from the telematics server 112 (312). In the instant case, communication between the AVN 230 and the telematics server 112 may be achieved through a mobile communication network including a Long Term Evolution (LTE) network.

To receive the hash key and the decryption key from the telematics server 112, the AVN 230 needs to be switched from a sleep mode to a wakeup mode. The above operation for switching the AVN 230 to the wakeup mode is needed only when keys are generated and transmitted from the telematics server 112. Therefore, if the user (driver) desires to control the vehicle 100, this means that the AVN 230 has already been switched to the wakeup mode and has received necessary keys and data. As a result, the exemplary embodiment of the present invention may not generate the user's standby time caused by wakeup of the AVN 230.

The AVN 230 may confirm whether the vehicle 100 is parked and the hash key is received (314). The operation for confirming whether the vehicle 100 is parked may include turning off engine ignition of the vehicle 100, shifting a gearshift lever to a parking mode (P), and locking doors of the vehicle 100. The reason why the operation for confirming whether the vehicle 100 is parked is performed is to unlock doors of the vehicle only when the vehicle 100 is parked. The reason why the operation for confirming reception or non-reception of the hash key is performed to perform a task requested by the mobile device 120 is achieved only when the hash key is received.

The AVN 230 may transmit its own hash key through Bluetooth communication (316). In the instant case, a method for transmitting the hash key is a broadcasting method for transmitting the hash key to unspecified people instead of a specific target. Therefore, the hash key transmitted from the AVN 230 may be received by all kinds of devices configured for accessing the Bluetooth communication network.

The AVN 230 may receive data through Bluetooth communication (318). As a result, the environment in which the AVN 230 receives data by accessing the Bluetooth communication network may be provided.

The mobile device 120 may receive data through the Bluetooth communication network (308). In the instant case, when the user approaches the vehicle 100 to use the vehicle 100, the mobile device 120 may access the Bluetooth communication network located in a peripheral region of the vehicle 100, and may receive the hash key through the accessed Bluetooth communication network (320).

To confirm that the hash key received through the Bluetooth communication network is identical to a hash key transmitted to the mobile device 120, the mobile device 120 may determine whether the hash key (i.e., hash key transmitted from the server) received from the telematics server 112 in operation 306 is identical to the hash key (i.e., hash key transmitted from the AVN) received through the Bluetooth communication network in operation 320 (322).

If the hash key received from the telematics server 112 is identical to the hash key received through the Bluetooth communication network (Yes in 322), the mobile device 120 may enter a standby mode for waiting for a predetermined time to allow the user to perform biometric recognition using the mobile device 120 (324).

The biometric recognition standby time may be a predetermined standby time. When biometric recognition of the user is not achieved until the predetermined standby time has expired (Time excess' in 324), the mobile device 120 may return to the standby mode for waiting for data reception through the Bluetooth communication network (308), and may repeatedly perform the next steps starting from the operation 308.

If the user performs the biometric recognition process through the mobile device 120, it is determined whether the user's biometric information is identical to biometric information registered in the mobile device 120 (326). The biometric information may be fingerprint or iris information related to the user. The biometric recognition process may refer to a process for comparing fingerprint or iris information related to the user with fingerprint or iris information registered in the mobile device 120. The scope or spirit of the biometric information related to the present invention is not limited to fingerprint or iris information, and the biometric information may further include face, cornea, hand shape, veins, voice, etc. of the user as necessary.

If the user's biometric information is not identical to the biometric information registered in the mobile device 120 (‘Not Identical’ in 326), the mobile device 120 may return to the standby mode for waiting for data reception through the Bluetooth communication network (308), and may repeatedly perform the next steps after the operation 308.

If the user's biometric information is identical to the biometric information registered in the mobile device 120 (‘Identical’ in 326), the mobile device 120 may encrypt a command for unlocking doors of the vehicle (328), and may transmit the encrypted door unlocking command through the Bluetooth communication network (330). In the instant case, a method for transmitting data through the Bluetooth communication network is a broadcasting method for transmitting data to unspecified people instead of a specific target. Therefore, the encrypted data transmitted from the mobile device 120 may be received by all kinds of devices configured for accessing the Bluetooth communication network.

In the instant case, data to be transmitted after being encrypted is not limited to the door unlocking command, and may be another data needed when the user drives the vehicle 100. For example, the data to be transmitted after being encrypted may be data needed to start engine ignition of the vehicle 100.

The mobile device 120 may transmit the encrypted data (i.e., the door unlocking command) through the Bluetooth communication network, and may discard a legacy hash key and a legacy encryption key having already been received (332). The currently received hash and encryption keys have already been used to encrypt/transmit data of the door unlocking command. The mobile device 120 may receive new hash and encryption keys in future, generating new data (commands) in future.

The AVN 230 may receive data through the Bluetooth communication network (318). In the instant case, the AVN 230 may receive the door unlocking command that has already been encrypted and transmitted by the mobile device 120 in operations 328 and 330, through the Bluetooth communication network (334).

Subsequently, the AVN 230 may decrypt (or decode) the received door unlocking command, and may unlock doors of the vehicle 100 (336). Since the door unlocking command transmitted from the mobile device 120 to the AVN 230 is based on the same hash key, the AVN 230 may confirm that the corresponding data (i.e., the encrypted door unlocking command) is identical to data having already been transmitted to the AVN 230. The AVN 230 may transmit the door unlocking command to the remote control module (or the smart key module) 238, unlocking doors of the vehicle.

The AVN 230 having performed to a series of data reception and control steps may release connection to the Bluetooth communication network, and may interrupt data reception through the Bluetooth communication network (338).

The AVN 230 may discard a legacy hash key and a legacy decryption key having already been received (340). Since the currently received hash key and decryption key have already been used to unlock doors of the vehicle through decryption of the door unlocking command data, the current hash key and decryption key may be discarded. The AVN 230 may receive a new hash key and a new decryption key in future, and may process new data (command).

The AVN 230 having received the series of data reception and control steps may request that the telematics server 112 generate a new hash key and new encryption/decryption keys (342). The telematics server 112 may generate new hash key and new encryption/decryption keys in a response to a request from the AVN 230, may perform synchronization between the generated keys in the same manner as in operations 304 and 310, and may simultaneously transmit the resultant keys to the mobile device 120 and the AVN 230.

From among the series of operations shown in FIG. 3, there are only two parts in which user intervention is needed, i.e., one portion 301 in which the user executes the vehicle control App of the mobile device 120 and the other portion in which the mobile device 120 performs biometric recognition of the user. The vehicle control App is executed by only one manipulation of the user and continuously remains activated, such that the user need not repeatedly perform manipulation for executing the vehicle control App. A user standby time to be consumed when the doors of the vehicle are locked or unlocked is only a time period needed for biometric recognition of the user. For example, assuming that fingerprint recognition is used as biometric recognition of the user, the biometric recognition may be achieved by the user who touches his or her finger tip on a specific position of the mobile device 120, such that a time needed for the user biometric recognition is very short.

As described above, a behavior needed for the user who desires to lock/unlock doors of the vehicle 100 only using the mobile device 120 without carrying a key (physical key or smart key) of the vehicle 100 is considered very simple for biometric recognition only. Furthermore, a standby time during which the user has to stay in front of the vehicle 100 to lock/unlock the doors of the vehicle 100 is also very short because the user has only to touch the mobile device 120 for biometric recognition. In a method for simply and rapidly controlling the vehicle 100 according to the exemplary embodiment of the present invention, when actually controlling the vehicle 100, the mobile device 120 and the AVN 230 may exchange necessary data with each other through a short-range communication network (e.g., BLE) without passing through the telematics server 112 and may require only a very simple process called biometric recognition for user authentication. Furthermore, the exemplary embodiments of the present invention may acquire higher security due to user authentication based on biometric recognition. As is apparent from the above description, a system and method for controlling a vehicle according to the exemplary embodiments of the present invention may reduce a standby time of a user who controls the vehicle using a mobile device, may minimize the number of user manipulation times, and may guarantee higher security.

Although a few embodiments of the present invention have been shown and described, it would be appreciated by those skilled in the art that changes may be made in these embodiments without departing from the principles and spirit of the invention, the scope of which is defined in the claims and their equivalents.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A system for controlling a vehicle comprising:
a transceiver receives a hash key, an encryption key received from a server, an encrypted control command through biometric authentication information received from a user from a mobile device; and
a controller configured to receive the encrypted control command from the mobile device through a short-range communication network, decrypt the encrypted control command using a hash key and a decryption key received from the server, and perform control corresponding to the control command.

2. The system according to claim 1, wherein the biometric authentication is achieved using biometric information related to the user of the mobile device.

3. The system according to claim 1, wherein
communication with the server is achieved through a mobile communication network; and
communication between the mobile device and the controller is achieved through the short-range communication network.

4. The system according to claim 1, wherein the control command is automatically generated after completion of the biometric authentication.

5. The system according to claim 1, wherein the short-range communication network is a Bluetooth communication network.

6. The system according to claim 1, wherein the control command is a command for unlocking at least one door of the vehicle.

7. The system according to claim 6, wherein the command for unlocking the at least one door of the vehicle is generated only when the vehicle is parked.

8. A method for controlling a vehicle comprising:
receiving a hash key and a decryption key from a server through a mobile communication network;
receiving an encrypted control command generated through biometric authentication of a user of a mobile device from the mobile device through a short-range communication network; and
decrypting the encrypted control command received from the mobile device, and performing control corresponding to the control command.

9. The method according to claim 8, wherein the control command is automatically generated after completion of the biometric authentication.

10. The method according to claim 8, wherein the control command is a command for unlocking at least one door of the vehicle.

11. The method according to claim 11, wherein the command for unlocking the at least one door of the vehicle is generated only when the vehicle is parked.

12. A method for controlling a vehicle comprising:
when an application for controlling the vehicle is executed, receiving a hash key and an encryption key from a server through a mobile communication network;
accessing a short-range communication network located in a peripheral region of the vehicle, and receiving a hash key transmitted through the short-range communication network;
when the hash key received from the server is identical to the hash key received through the short-range communication network, entering a standby mode until biometric authentication of a user is completed; and
when the biometric authentication of the user is completed, encrypting a control command for controlling the vehicle and transmitting the encrypted control command to the vehicle through the short-range communication network, such that the vehicle having received the control command performs control corresponding to the control command.

13. The method according to claim 12, wherein the biometric authentication is achieved using biometric information related to the user in the mobile device held by the user.

14. The method according to claim 12, wherein the control command is automatically generated after completion of the biometric authentication.

15. The method according to claim 12, wherein the control command is a command for unlocking at least one door of the vehicle.

16. The method according to claim 15, wherein the command for unlocking the at least one door of the vehicle is generated only when the vehicle is parked.

17. A method for controlling a vehicle comprising:
when an application for controlling the vehicle is executed, receiving a hash key and an encryption key from a server through a mobile communication network;
receiving a hash key and a decryption key from the server through the mobile communication network;
accessing a short-range communication network located in a peripheral region of the vehicle, and receiving a hash key transmitted through the short-range communication network;
when the hash key received from the server is identical to the hash key received through the short-range communication network, entering a standby mode until biometric authentication of a user is completed;
when the biometric authentication of the user is completed, encrypting a control command for controlling the vehicle, and transmitting the encrypted control command to the vehicle through the short-range communication network;
receiving the encrypted control command generated through the user biometric authentication of a mobile device from the mobile device through the short-range communication network; and
decrypting the encrypted control command received from the mobile device, and performing control corresponding to the control command.

18. The method according to claim 17, wherein the control command is automatically generated after completion of the biometric authentication.

19. The method according to claim 17, wherein the control command is a command for unlocking at least one door of the vehicle.

20. The method according to claim 19, wherein the command for unlocking the at least one door of the vehicle is generated only when the vehicle is parked.
